(19) United States
(12) Patent Application Publication
(10) Pub. No.: US 2025/0376066 A1
(43) Pub. Date: Dec. 11, 2025

(54) AUTOMATIC SELECTION OF A CONTRACT CERTIFICATE TO FACILITATE ELECTRIC VEHICLE CHARGING

(71) Applicant: SCOUT MOTORS INC., Tysons, VA (US)

(72) Inventor: Matt Thomas, Howell, MI (US)

(21) Appl. No.: 18/737,242

(22) Filed: Jun. 7, 2024

(51) Int. Cl. B60L 53/66; B60L 53/65

(52) U.S. Cl. CPC B60L 53/665; B60L 53/65; B60L 2240/60; B60L 2250/16

(57) ABSTRACT

An apparatus and method are provided for automatically selecting a contract certificate to facilitate charging of a battery of an electric vehicle at a charging station. A candidate charging station is at which the battery of the electric vehicle is capable of being charged is automatically determined. Based on the operator of the candidate charging station, a first contract certificate from among a plurality of contract certificates is then identified to be active to facilitate use at the candidate charging station. Information from the first contract certificate may then be provided to the charging station to allow for authentication of the electric vehicle for recharging purposes. An electric vehicle is also provided that is configured to automatically select a contract certificate to facilitate charging of its battery at a charging station.

### BACKGROUND

The battery of an electric vehicle must be occasionally recharged in order for the electric vehicle to remain operational. Public charging stations have therefore been installed and are available for use by drivers of electric vehicles. In order to utilize a charging station, payment must be provided by the driver or owner of the electric vehicle to the operator of the charging station. The payment may be provided in several different forms, such as by presentation of a credit or debit card, presentation of a radio frequency identification (RFID) card or fob that is linked to a payment application, or utilization of a mobile payment app. Additionally, a plug and charge (PnC) system has been developed to allow the battery of an electric vehicle to be recharged by a charging station with the payment information provided by a contract certificate that is maintained by the electric vehicle.

The public charging stations may be owned and operated by a number of different operators. In order to utilize charging stations of different operators in order to recharge the battery of an electric vehicle, the driver or owner of the electric vehicle must maintain a plurality of contract certificates, one of which is associated with each different operator of the charging stations to be utilized by the electric vehicle. Prior to charging the electric vehicle at a particular charging station, the driver or owner of the electric vehicle must therefore identify the operator of the particular charging station and then identify the contract certificate associated with the operator of the particular charging station in order to provide the necessary payment information to allow the battery of the electric vehicle to be charged by the particular charging station. However, the identification by the driver or owner of the electric vehicle of the operator of a particular charging station and, in turn, of the contract certificate associated with the operator of the particular charging station is time consuming and may become increasingly time consuming as public charging stations owned or operated by additional operators are placed into service.

### SUMMARY

A method and apparatus are provided for automatically selecting a contract certificate to facilitate charging of the battery of an electric vehicle at a charging station. By automatically selecting the contract certificate, the method and apparatus provide for a quick and accurate charging process by correctly identifying the operator of the charging station and the corresponding contract certificate such that the information defined by the contract certificate may be efficiently provided to the charging station in order to allow the electric vehicle to be authorized to be recharged by the charging station in a timely manner. In some embodiments, the contract certificate may be automatically identified in advance of the arrival of the electric vehicle to the charging station in order to further expedite the charging process. An electric vehicle that is configured to automatically select a contract certificate to facilitate charging of the battery of the electric vehicle at the charging station is also provided in accordance with another embodiment.

In some embodiments, an apparatus is provided that is configured to automatically select a contract certificate to facilitate charging of a battery of an electric vehicle at a charging station. The apparatus includes a memory that is configured to store a plurality of contract certificates. Each contract certificate is associated with a respective operator of one or more charging stations and is configured to provide payment information associated with the electric vehicle to the operator. The apparatus also includes a controller configured to automatically determine a candidate charging station at which the battery of the electric vehicle is capable of being charged. The controller is further configured automatically to identify a first contract certificate from among the plurality of contract certificates stored by the memory to be active to facilitate use at the candidate charging station. The controller is configured to automatically identify the first contract certificate in a manner that is dependent upon a respective operator of the candidate charging station.

In an instance in which a route is defined for the electric vehicle that includes a charging stop at a charging station, the controller of some embodiments is configured to automatically determine the candidate charging station to be the charging station at the charging stop of the route. In another embodiment, the controller is configured to automatically determine the candidate charging station based on a proximity of the electric vehicle to the candidate charging station. In a further embodiment, the controller is configured to automatically determine the candidate charging station based on the frequency with which the battery of the electric vehicle has previously been charged at one or more charging stations. For example, the controller of this embodiment may be configured to automatically determine the candidate charging station at which the battery of the electric vehicle has been most frequently charged to be the candidate charging station.

The controller of some embodiments is further configured to provide information associated with the first contract certificate that has been identified to be active to the charging station. For example, the first contract certificate may include information that identifies a user of the first contract certificate and payment information. In some embodiments, the memory is configured to store the plurality of contract certificates by storing a charging POI database that assigns POIs to respective charging stations. The charging POI database includes contract certificates associated with respective POIs.

In some embodiments, a method is provided for automatically selecting a contract certificate to facilitate charging of a battery of an electric vehicle at a charging station. The method includes storing a plurality of contract certificates. Each contract certificate is associated with a respective operator of one or more charging stations and is configured to provide payment information associated with the electric vehicle to the respective operator. The method also includes automatically determining a candidate charging station at which the battery of the electric vehicle is capable of being charged. The method further includes automatically identifying a first contract certificate from among the plurality of contract certificates to be active to facilitate use at the candidate charging station. The automatic identification of the first contract certificate includes automatically identifying the first contract certificate depending upon the respective operator of the candidate charging station.

In an instance in which a route is defined for the electric vehicle that includes a charging stop at a charging station, the method of some embodiments automatically determines the candidate charging station to be the charging station at the charging stop at the route. In another embodiment, the method automatically determines a candidate charging station based on a proximity of the electric vehicle to the candidate charging station. In a further example embodiment, the method automatically determines a candidate charging station based on a frequency with which the battery of the electrical vehicle has previously been charged at one or more charging stations. For example, the method of some embodiments may automatically determine the candidate charging station by determining the charging station at which the battery of the electric vehicle has most frequently been charged to be the candidate charging station.

The method of some embodiments also includes providing information associated with the first contract certificate that has been identified to be active to the charging station. The first contract certificate may include information that identifies a user of the first contract certificate and payment information. In some embodiments, the method stores the plurality of contract certificates by storing a charging point of interest (POI) database that assigns POIs to respective charging stations. In this embodiment, the charging POI database includes contract certificates associated with respective POIs.

In some embodiments, an electric vehicle is provided that includes a vehicle body and a battery carried by the vehicle body and configured to controllably provide electrical energy to one or more motors which provide motive force. The electric vehicle also includes a memory configured to store a plurality of contract certificates. Each contract certificate is associated with a respective operator of one or more charging stations and is configured to provide payment information associated with the electric vehicle to the respective operator. The electric vehicle also includes a controller configured to automatically determine the candidate charging station at which the battery of the electric vehicle is capable of being charged. The controller is further configured to automatically identify a first contract certificate from among the plurality of contract certificates stored by the memory to be active to facilitate use at the candidate charging station in order to charge the battery of the electric vehicle. The controller is configured to automatically identify the first contract certificate in a manner that is dependent upon the respective operator of the candidate charging station.

In an instance in which a route is defined for the electric vehicle that includes a charging stop at a charging station, the controller of some embodiments of the electric vehicle is configured to automatically determine the candidate charging station to be the charging station at the charging stop at the route. In another embodiment, the controller is configured to automatically determine the candidate charging station based on the proximity of the electric vehicle to the candidate charging station. In a further embodiment, the controller of the electric vehicle is configured to automatically determine a candidate charging station based on the frequency with which the battery of the electric vehicle has previously been charged at one or more charging stations, such as by automatically determining the charging station at which the battery of the electric vehicle has been most frequently charged to be the candidate charging station.

### BRIEF DESCRIPTION OF THE DRAWINGS

Having thus described some embodiments of the present disclosure in general terms, reference will hereinafter be made to the accompanying drawings, which are not necessarily drawn to scale, and wherein:

FIG. 1 is a perspective view of an electric vehicle at a charging station in order to recharge a battery of the electric vehicle based on a contract certificate that has been automatically identified in accordance with some embodiments of the present disclosure;

FIG. 2 is a schematic representation of an electric vehicle configured to automatically select a contract certificate in accordance with some embodiments;

FIG. 3 is a block diagram of an apparatus configured to automatically select a contract certificate to facilitate charging of the battery at a charging station in accordance with some embodiments of the present disclosure; and

FIG. 4 is a flow chart illustrating operations performed in order to automatically select a contract certificate to facilitate charging of a battery of an electric vehicle at a charging station in accordance with some embodiments of the present disclosure.

### DETAILED DESCRIPTION

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

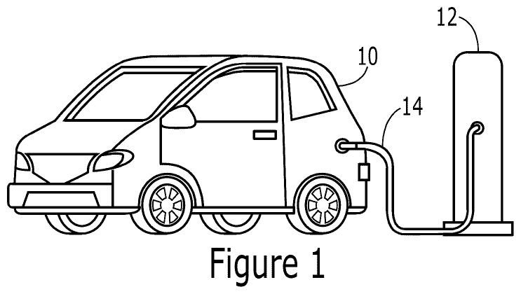

A method, apparatus, and associated electric vehicle are provided for automatically selecting a contract certificate to facilitate charging of a battery of the electric vehicle at a charging station. As used herein, an electric vehicle includes any vehicle that is fully or partially battery-powered including a fully battery-powered electric vehicle (BEV), and also a hybrid electric vehicle (HEV) or a plug-in hybrid electric vehicle (PHEV). To support use of electric vehicles, a plurality of charging stations have been installed in a wide variety of locations and are available for use by electric vehicles in order to recharge the batteries of the electric vehicles, typically for a fee. The charging stations are owned and/or operated by a plurality of different operators. For example, a first subset of the charging stations may be owned or operated by a first operator, a second subset of the charging stations may be owned or operated by a second operator, and so forth. The driver, owner or other person associated with an electric vehicle (hereinafter generally referenced as the driver of the electric vehicle) that is utilizing a charging station to recharge its battery can pay the operator for the power delivered to the vehicle during the recharging process in various manners. For example, the driver may pay the operator of the charging station utilizing a credit card, or the driver may pay the operator utilizing a mobile app or by presenting an RFID tag. However, a plug and charge (PnC) system has been developed to allow drivers of electric vehicles to connect their electric vehicle 10 to a charging station 12 utilizing a charging cable 14 as shown in FIG. 1, and for the charging station and the electric vehicle to communicate in order to arrange for payment of the operator of the charging station without further interaction by the driver.

In order to provide payment authorization to the operator of the charging station 12, a contract certificate is defined that identifies the certificate holder, such as by identifying the driver or otherwise identifying the owner of the contract certificate, such as the owner of the electric vehicle 10 in an instance in which the driver is not the owner, and provides payment information. The contract certificate may be obtained by the certificate holder in advance with the contract certificate being associated with a particular operator of charging stations 12. The contract certificate may be stored by the electric vehicle 10 for use in an instance in which the electric vehicle is recharged by a charging station 12 that is owned or operated by the operator associated with the particular contract certificate.

In a plug and charge scenario, information from the contract certificate, including the payment information, is provided by the electric vehicle 10 to the charging station 12. This information may be provided to the charging station 12 in a secure manner with the information being encrypted and subjected to authentication by the charging station, such as two-way authentication. Although the information, including the payment information, may be conveyed in various manners, the information from the contract certificate may be provided to the charging station 12 via a charging interface that operates in accordance with international standard ISO 15118, which provides for secure communication in a plug and charge scenario. Once the information from the contract certificate has been provided by the electric vehicle 10 to the charging station 12, the battery of the electric vehicle may then be charged by the charging station.

Although the use of contract certificates, such as in conjunction with plug and charge technology, is intended to simplify the charging process for the driver of an electric vehicle 10, the proliferation of charging stations 12 that are owned and/or operated by different operators has caused owners of electric vehicles to obtain and store a number of different contract certificates, one of which is associated with and utilized in conjunction with the charging station(s) of each of the different operators. As such, the driver of an electric vehicle 10 has had to determine the operator of a charging station 12 that the driver wishes to utilize and to then identify the contract certificate associated with the operator of the particular charging station in order to provide the information defined by the proper contract certificate to the charging station in order to authorize the charging process. This process increases the time expended to recharge electric vehicles 10 and increases the risk of errors, such as in an instance in which the incorrect operator of a charging station 12 is identified and/or in an instance in which the incorrect contract certificate is identified and attempted to be utilized in conjunction with the charging process.

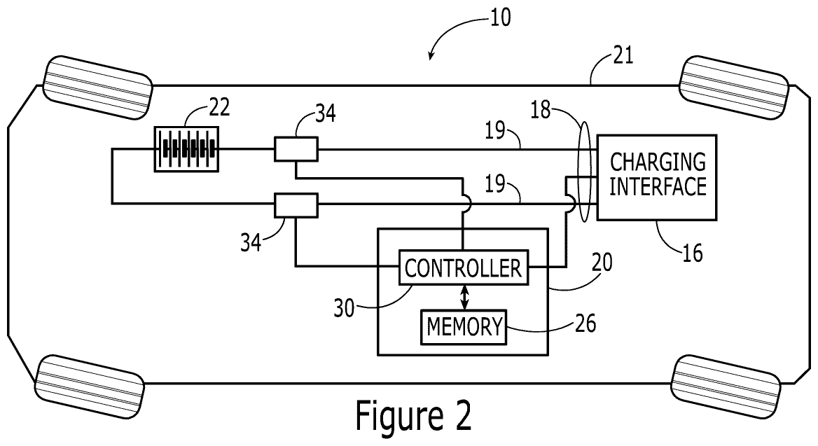

As such, the method, apparatus, and associated electric vehicle of an example embodiment of the present disclosure are configured to automatically select a contract certificate so as to facilitate charging of the battery of an electric vehicle 10 at a charging station 12, thereby increasing the speed, efficiency and accuracy with which information from a contract certificate is provided to a charging station to facilitate the recharging of the battery of the electric vehicle. As shown in FIG. 2, an electric vehicle 10 includes a vehicle body 21 and a battery 22 carried by the vehicle body and configured to provide electrical energy to one or more motors (not shown) of the electric vehicle 10, which in turn provide motive force to the electric vehicle 10. While a single battery 22 is depicted in FIG. 2, the electric vehicle 10 may include a plurality of batteries configured to operate in concert to controllably provide the requisite electrical energy to the electric vehicle. The electric vehicle 10 of some embodiments also includes a charging interface 16 including a charge port that is configured to receive the charging cable 14 of the charging station 12, such as a plug of the charging cable 14. A bus 18 extends from the charging interface 16 and through the electric vehicle 10 with a pair of conductors carrying the charging current and operating at the charging voltage that extend to the battery 22. The bus 18 also includes a communication link that relays a variety of information between the electric vehicle 10, such as a controller 30 of the electric vehicle as described below, and the charging station 12. The information relayed by the communication link may include the state of charge of the battery 22, the temperature, the charging time and the charging voltage as well as safety-related information, such as an indication that the electric vehicle 10 is in park and an indication causing the charging cable 14 to be locked to the charging interface 16 during the charging process.

As shown in FIG. 2, the electric vehicle 10 of some embodiments may also include a plurality of contactors 34 configured to controllably connect the batteries 22 to the charging station 12. In this regard, the pair of conductors of the bus 18 carrying the charging current and operating at the charging voltage may extend from the charging interface 16 to respective ones of the contactors 34. The contactors 34 may, in turn, be connected, to the battery, either directly or via a switch bank. The contactors 34 may be opened and closed based on control signaling provided by the controller 30, thereby controlling the delivery of the charging current to the battery 22.

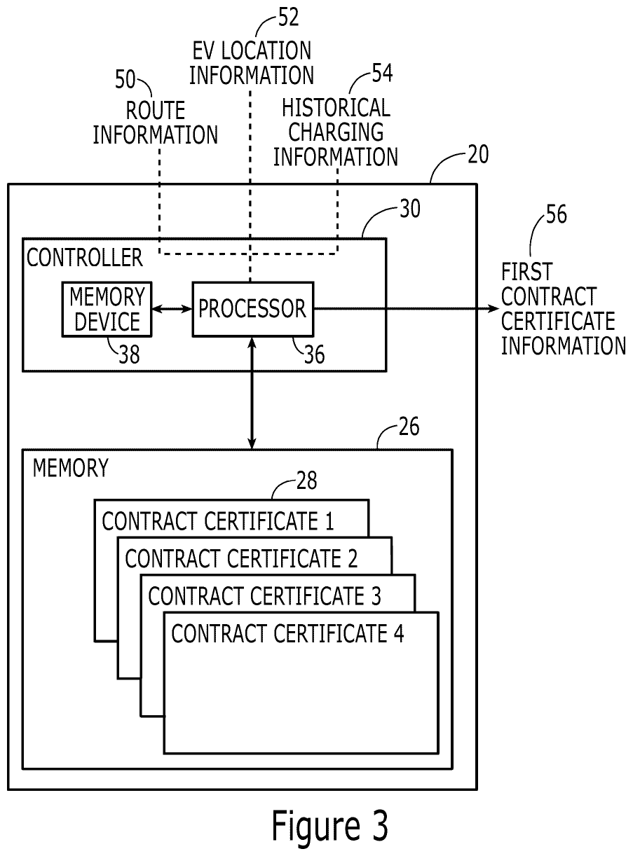

As shown in FIG. 2 and in more detail in FIG. 3, the electric vehicle 10 of some embodiments also includes an apparatus 20 configured to automatically select a contract certificate to facilitate charging of the battery 22 of the electric vehicle at a charging station 12. The apparatus 20 includes a memory 26 that is configured to store a plurality of contract certificates 28. In the illustrated embodiment, the memory 26 is shown to store four contract certificates 28 associated with four different operators of charging stations 12. However, the memory 26 may store any number of contract certificates in other embodiments. Each contract certificate is associated with, such as by being dedicated to, a respective operator of one or more charging stations 12. Each contract certificate stored by the memory 26 includes information identifying the electric vehicle 10, the certificate holder, such as the owner and/or driver of the electric vehicle, and payment information associated with the electric vehicle. As such, the memory 26 is configured to provide at least the payment information associated with the electric vehicle 10 to the respective operator of a charging station 12.

The apparatus 20 that automatically selects the contract certificate also includes a controller 30 configured to automatically determine a candidate charging station at which the battery 22 of the electric vehicle 10 is capable of being charged, as described below. The controller 30 is also configured to automatically identify a first contract certificate from among the plurality of contract certificates 28 stored by the memory 26 to be active to facilitate use at the candidate charging station in order to charge the battery 22 of the electric vehicle 10. As described below, the controller 30 is configured to automatically identify the first contract certificate in a manner that is dependent upon the respective operator of the candidate charging station, such as by automatically identifying the contract certificate from among the plurality of contract certificates 28 that is associated with the operator of the candidate charging station and not identifying the contract certificates associated with different operators of other charging stations.

The controller 30 can be configured in various manners, but in some embodiments it is configured as processing circuitry that may, in turn, be embodied as one or more of various hardware processing means such as a coprocessor, a microprocessor, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like.

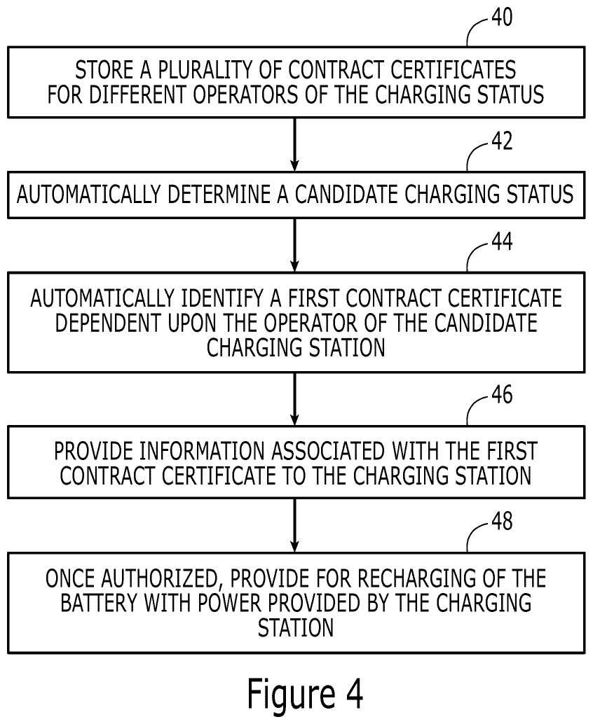

In some embodiments, the controller 30 may be configured to execute instructions stored in a memory device or otherwise accessible to the controller. Alternatively or additionally, the controller 30 may be configured to execute hard coded functionality. As such, whether configured by hardware or software methods, or by a combination thereof, the controller 30 may represent an entity (e.g., physically embodied in circuitry) capable of performing operations according to some embodiments of the present disclosure while configured accordingly. Thus, for example, when the controller 30 is embodied as an ASIC, FPGA or the like, the controller 30 may be specifically configured hardware for conducting the operations described herein. Alternatively, as another example, when the controller 30 is embodied as an executor of instructions, the instructions may specifically configure the controller to perform the algorithms and/or operations described herein when the instructions are executed. As shown in FIG. 3, for example, the controller 30 of some embodiments includes at least one processor 36 and a memory device 38. In some embodiments, the memory device 38 includes computer program code instructions stored thereon that, when executed by the processor 36, cause the controller 30 to perform the operations described below, such as in relation to FIG. 4. Although the memory device 38 is illustrated to be distinct from the memory 26 that stores the plurality of contract certificates 28, the memory device 38 and the memory 26 may be embodied by the same memory component in other embodiments.

The memory device 38 and the memory 26 (if distinct from the memory device 38) may be non-transitory and may include one or more volatile and/or non-volatile memories. For example, the memory device 38 and the memory 26 may be electronic storage device(s) (for example, a computer readable storage medium) comprising gates configured to store data (for example, bits) that may be retrievable and executed by the at least one processor 36. In addition to storing instructions, the memory device 38 and the memory 26 (if distinct from the memory device 38) may be configured to store information, data, content, applications, or the like for enabling the apparatus 20 to carry out various functions in accordance with some embodiments, as described in relation to FIG. 4 below.

In operation, the apparatus 20 of an example embodiment is configured to automatically select a contract certificate in the manner depicted in FIG. 4. As shown in block 40 of FIG. 4, the apparatus 20 of an example embodiment includes means, such as the memory 26 or the like, for storing a plurality of contract certificates, each of which is associated with a respective operator of one or more charging stations 12. Each contract certificate stored by the memory 26 includes information identifying the electric vehicle 10, the certificate holder, and payment information for the electric vehicle. The apparatus 20 also includes means, such as the controller 30 or the like, for automatically determining a candidate charging station at which the battery 22 of the electric vehicle 10 is capable of being charged. See block 42. The apparatus 20 further includes means, such as the controller 30 or the like, for subsequently automatically identifying a first contract certificate from among the plurality of contract certificates to be active to facilitate use of the first contract certificate at the candidate charging station. See block 44. In this regard, the controller 30 is configured to automatically determine the candidate charging station and automatically identify the first contract certificate in a manner that is independent of and does not require manual intervention such that the identification of the appropriate contract certificate is performed more efficiently and accurately than prior manual techniques.

As shown in block 46 of FIG. 4, the apparatus 20 also includes means, such as the controller 30, the charging interface 16 or the like, for providing information associated with the first contract certificate that has been identified to be active to the charging station 12. See, for example, the information 56 associated with the first contract certificate that is shown in FIG. 3 to be provided by the controller 30. The information associated with a first contract certificate may include information that identifies the certificate holder of the first contract certificate, such as the owner and/or driver of the electric vehicle 10, and payment information. The information maintained by the first contract certificate and provided to the charging station may optionally include other types of information, such as the identity of the electric vehicle 10. The apparatus 20, such as the controller 30 and/or the charging interface 18, may be configured to provide information associated with a first contract certificate to the charging station 12 in various manners. For example, the charging cable 14 that connects the electric vehicle 10 to the charging station 12 may include a communications link via which information is exchanged between the electric vehicle and the charging station, including information associated with the first contract certificate. For example, the controller 30 may be configured to provide the first contact certificate information to the charging interface 16 via the bus 18 and the charging interface may then direct the first contract certificate information to the charging station 12. Although information exchanged via the communications link may be provided in various manners, the information provided by the electric vehicle 10 of some embodiments to the charging station 12 may be encrypted and subject to two way authentication, such as defined by the ISO 15118 standard. The apparatus 20, such as the controller 30, the charging interface 16 or the like, of other example embodiments may provide information associated with the first contract certificate to the charging station 12 in other manners, such as via wireless communication.

Once information associated with the first contract certificate including the payment information of the certificate holder has been provided to the charging station 12 at which the electric vehicle 10 is to be recharged, the charging station can determine whether to authorize the charging of the electric vehicle. The charging station 12 may be configured to consider various parameters to determine whether the recharging request by the electric vehicle 10 should be authorized. For example, the charging station 12 may be configured to confirm that the first contract certificate is associated with the operator of the charging station and that the first contract certificate in general as well as the payment information more specifically are valid in order to authorize the charging of the electric vehicle 10. Once authorized, the charging station delivers power to the electric vehicle 10 and the apparatus 20, such as the controller 30, directs the contactors 34 to allow the power delivered by the charging station to flow to and recharge the battery 22 of the electric vehicle. See block 48 of FIG. 4. Based upon the amount of power delivered to the electric vehicle 10, the operator of the charging station 12 may then secure payment from the account maintained by the certificate holder of the first contract certificate, such as the account maintained by the owner and/or driver of the electric vehicle, in order to pay for the power that has been delivered.

As noted above with respect to block 42 of FIG. 4, the apparatus 20, such as the controller 30, is configured to automatically determine a candidate charging station at which the battery 22 of the electric vehicle 10 is capable of being charged. The apparatus 20 may be configured to automatically determine the candidate charging station in several different manners. In at least some embodiments, the candidate charging station is automatically determined in advance of the electric vehicle 10 arriving at the charging station 12. Thus, the contract certificate associated with the operator of the candidate charging station may also be automatically identified in advance of the electric vehicle 10 arriving at the charging station 12, thereby increasing the speed and efficiency with which the electric vehicle is authorized to be recharged by the charging station.

For example, in some embodiments, a route is predefined, such as by a navigation system onboard or otherwise in communication with the electric vehicle 10, that includes a charging stop at a charging station 12. Based on information 50 regarding the route, the apparatus 20, such as the controller 30, may be configured to automatically determine the candidate charging station to be the charging station 12 at the charging stop along the route. Once the candidate charging station has been automatically determined based on the charging stop along the route, the apparatus 20, such as the controller 30, of this embodiment may be configured to automatically identify the contract certificate that is associated with the operator of the candidate charging station at the charging stop of the route. The apparatus 20, such as the controller 30 and/or the charging interface 16, is therefore prepared to provide information associated with the contract certificate that has been identified to the charging station 12 upon reaching the charging stop along the route and connecting charging cable 14 of the charging station to the electric vehicle 10.

In another example embodiment, the apparatus 20, such as the controller 30, is configured to automatically determine the candidate charging station based on the proximity of the electric vehicle 10 to the candidate charging station. In this regard, the apparatus 20, such as the controller 30, may be configured to receive information 52 regarding the location of the electric vehicle 10, such as from a Global Positioning System (GPS) onboard the electric vehicle, and to automatically determine the candidate charging station to be the charging station 12 that is closest to the electric vehicle at the current time. Based on the identification of the candidate charging station, such as the charging station 12 that is currently the closest to the electric vehicle 10, the apparatus 20, such as the controller 30, of this embodiment may also be configured to automatically identify the contract certificate associated with the operator of the candidate charging station. The apparatus 20, such as the controller 30 and/or the charging interface 16, is therefore prepared to provide information associated with the contract certificate that has been identified to the charging station 12 if the driver of the electric vehicle 10 directs the electric vehicle to the charging station that has been determined based on its proximity to the electric vehicle and the charging cable 14 of the charging station is then connected to the electric vehicle.

The timing with which the contract certificate is identified may be defined in various matters. For example, the contract certificate may be identified automatically each time that a candidate charging station 12 is newly identified. Alternatively, the contract certificate may be identified following the identification of a candidate charging station 12 once the electric vehicle 10 is within a predefined distance of the charging station and/or once the electric vehicle has slowed to a speed no more than a predefined speed limit, both of which may indicate an increased likelihood that the electric vehicle is being driven to the candidate charging station.

In this example embodiment, the apparatus 20, such as the controller 30, may be configured to repeatedly determine the candidate charging station since different charging stations 12 may become the closest to the electric vehicle 10 as the electric vehicle is driven. Thus, even in an instance in which the apparatus 20, such as the controller 30, of this embodiment has determined the candidate charging station based on its proximity to the electric vehicle 10 at one point in time, the apparatus, such as the controller, is configured to repeatedly evaluate the charging stations based on the proximity of electric vehicle to the charging stations at subsequent points in time and may thereafter determine a different charging station to be the candidate charging station, such as in an instance in which the electric vehicle becomes closer to the different charging station at a subsequent point in time as the electric vehicle is driven.

By way of example, the electric vehicle 10 may approach a first charging station 12 as the electric vehicle is driven along a roadway. As the first charging station 12 is the closest charging station to the electric vehicle 10 at a first point in time, the apparatus 20, such as the controller 30, may be configured to automatically determine the first charging station 12 to be the candidate charging station at least at the first point in time. In an instance in which the electric vehicle 10 does not stop at the first charging station 12, but continues to drive along the roadway, the apparatus 20, such as the controller 30, may repeatedly evaluate the proximity of charging stations to the electric vehicle. In an instance in which the electric vehicle 10 drives so as to become closer to a second charging station then the first charging station, such as in an instance in which the electric vehicle is driven past the first charging station and becomes closer to the second charging station at a second point in time, the apparatus 20, such as the controller 30, of this example embodiment is configured to automatically determine the second charging station to be the candidate charging station.

In a further embodiment, the apparatus 20, such as the controller 30, is configured to automatically determine the candidate charging station based on the frequency with which the battery 22 of the electric vehicle 10 has previously been charged at one or more charging stations 12. As shown in FIG. 3, the controller 30 may be configured to receive historical charging information 54, such as from a charging database, that identifies the charging stations 12 at which the electrical vehicle 10 has recharged at different points in time in the past. Although the controller 30 is depicted to receive the historical charging information 54, the historical charging information may, instead, be stored by and accessible in the memory device 38. Based upon the historical charging information 54, the apparatus 20, such as the controller 30, may be configured to automatically determine the charging station 12 at which the battery 22 of the electric vehicle 10 has most frequently been charged to be the candidate charging station. The frequency with which charging stations have been utilized to recharge the battery 22 of the electric vehicle 10 may be determined over a most recent period of time, such as the last month, the last quarter, or over some other period of time. Alternatively, the apparatus 20, such as the controller 30, may be configured to automatically determine the charging station 12 at which the battery 22 of the electric vehicle 10 has most recently been charged to be the candidate charging station. In some embodiments, the apparatus 20, such as the controller 30, may be configured to evaluate only those charging stations 12 that are within a predefined proximity of the electric vehicle 10 at the current point of time, such as within a predefined radius of the electric vehicle, in assessing the frequency with which the battery 22 of the electric vehicle has been charged at the charging stations.

The apparatus 20, such as the memory 26, may be configured to store the plurality of the contract certificates 28 in various manners. For example, the memory 26 may be configured to store the contract certificates 28 in association with an indication of the operator of the charging station(s) 12 with which each contract certificate is associated. As such, the controller 30 can efficiently identify the contract certificate that is associated with the operator of the candidate charging point that has been automatically determined. Alternatively, the memory 26 may be configured to store a charging point of interest (POI) database. The charging POI database assigns POIs to respective charging stations 12. The charging POI database includes not only POIs that are assigned to respective charging stations, but also the contract certificates associated with respect to the POIs. As such, the apparatus 20, such as the controller 30, of this embodiment can reference the charging POI database in order to identify the POI of a respective charging station and, in turn, obtain the contract certificate associated with the particular POI.

A method and apparatus 20 are therefore provided for automatically selecting a contract certificate to facilitate charging of the battery 22 of an electric vehicle 10 at a charging station 12. By automatically selecting the contract certificate, the method and apparatus 20 provide for a timely and accurate charging process by correctly identifying the operator of the charging station 12 and the corresponding contract certificate that is stored in memory 26 of the electric vehicle 10. The information defined by the contract certificate may therefore be efficiently provided to the charging station 12 in order to allow the electric vehicle 10 to be authorized to be recharged by the charging station in a timely manner. An electric vehicle 10 is also provided in accordance with other embodiments that is configured to automatically select a contract certificate to facilitate charging of the battery 22 of the electric vehicle at the charging station 12.

FIG. 4 illustrates a flowchart depicting a method according to an example aspect of the present disclosure. It will be understood that each block of the flowchart and combination of blocks in the flowchart may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 38 of the apparatus 20 and executed by the at least one processor 36. As will be appreciated, any such computer program instructions may be loaded into a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded into a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, may be implemented by special purpose hardware-based computer systems which perform the specified functions, or combinations of special purpose hardware and computer instructions.

Many modifications and other embodiments of the present disclosure will come to mind to one skilled in the art to which this disclosure pertains having the benefit of the teachings presented in the foregoing descriptions and the associated drawings. Therefore, it is to be understood that the disclosure is not to be limited to the specific embodiments described above and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus configured to automatically select a contract certificate to facilitate charging of a battery of an electric vehicle at a charging station, the apparatus comprising:
a memory configured to store a plurality of contract certificates, each contract certificate associated with a respective operator of one or more charging stations and configured to provide payment information associated with the electric vehicle to the respective operator; and
a controller configured to automatically determine a candidate charging station at which the battery of the electric vehicle is capable of being charged, wherein the controller is further configured to automatically identify a first contract certificate from among the plurality of contract certificates stored by the memory to be active to facilitate use at the candidate charging station, and wherein the controller is configured to automatically identify the first contract certificate in a manner that is dependent upon the respective operator of the candidate charging station.

2. An apparatus according to claim 1 wherein, in an instance in which a route is defined for the electric vehicle that includes a charging stop at a charging station, the controller is configured to automatically determine the candidate charging station to be the charging station at the charging stop of the route.

3. An apparatus according to claim 1 wherein the controller is configured to automatically determine the candidate charging station based on a proximity of the electric vehicle to the candidate charging station.

4. An apparatus according to claim 1 wherein the controller is configured to automatically determine the candidate charging station based on a frequency with which the battery of the electric vehicle has previously been charged at one or more charging stations.

5. An apparatus according to claim 4 wherein the controller is configured to automatically determine the candidate charging station by automatically determining the charging station at which the battery of the electric vehicle has most frequently been charged to be the candidate charging station.

6. An apparatus according to claim 1 wherein the controller is further configured to provide information associated with the first contract certificate that has been identified to be active to the charging station.

7. An apparatus according to claim 6 wherein the first contract certificate includes information that identifies a user of the first contract certificate and payment information.

8. An apparatus according to claim 1 wherein the memory is configured to store the plurality of contract certificates by storing a charging point of interest (POI) database that assigns POIs to respective charging stations, wherein the charging POI database comprises contract certificates associated with respective POIs.

9. A method for automatically selecting a contract certificate to facilitate charging of a battery of an electric vehicle at a charging station, the method comprising:
storing a plurality of contract certificates, each contract certificate associated with a respective operator of one or more charging stations and configured to provide payment information associated with the electric vehicle to the respective operator;
automatically determining a candidate charging station at which the battery of the electric vehicle is capable of being charged; and
automatically identifying a first contract certificate from among the plurality of contract certificates to be active to facilitate use at the candidate charging station, wherein automatically identifying the first contract certificate comprises automatically identifying the first contract certificate dependent upon the respective operator of the candidate charging station.

10. A method according to claim 9 wherein, in an instance in which a route is defined for the electric vehicle that includes a charging stop at a charging station, automatically determining the candidate charging station comprises automatically determining the candidate charging station to be the charging station at the charging stop of the route.

11. A method according to claim 9 wherein automatically determining the candidate charging station comprises automatically determining the candidate charging station based on a proximity of the electric vehicle to the candidate charging station.

12. A method according to claim 9 wherein automatically determining the candidate charging station comprises automatically determining the candidate charging station based on a frequency with which the battery of the electric vehicle has previously been charged at one or more charging stations.

13. A method according to claim 12 wherein automatically determining the candidate charging station further comprises automatically determining the charging station at which the battery of the electric vehicle has most frequently been charged to be the candidate charging station.

14. A method according to claim 9 further comprising providing information associated with the first contract certificate that has been identified to be active to the charging station.

15. A method according to claim 14 wherein the first contract certificate includes information that identifies a user of the first contract certificate and payment information.

16. A method according to claim 9 wherein storing the plurality of contract certificates comprises storing a charging point of interest (POI) database that assigns POIs to respective charging stations, wherein the charging POI database comprises contract certificates associated with respective POIs.

17. An electric vehicle comprising:
a vehicle body;
a battery carried by the vehicle body and configured to controllably provide motive force;
a memory configured to store a plurality of contract certificates, each contract certificate associated with a respective operator of one or more charging stations and configured to provide payment information associated with the electric vehicle to the respective operator; and
a controller configured to automatically determine a candidate charging station at which the battery of the electric vehicle is capable of being charged, wherein the controller is further configured to automatically identify a first contract certificate from among the plurality of contract certificates stored by the memory to be active to facilitate use at the candidate charging station in order to charge the battery of the electric vehicle, and wherein the controller is configured to automatically identify the first contract certificate in a manner that is dependent upon the respective operator of the candidate charging station.

18. An electric vehicle according to claim 17 wherein, in an instance in which a route is defined for the electric vehicle that includes a charging stop at a charging station, the controller is configured to automatically determine the candidate charging station to be the charging station at the charging stop of the route.

19. An electric vehicle according to claim 17 wherein the controller is configured to automatically determine the candidate charging station based on a proximity of the electric vehicle to the candidate charging station.

20. An electric vehicle according to claim 17 wherein the controller is configured to automatically determine the candidate charging station based on a frequency with which the battery of the electric vehicle has previously been charged at one or more charging stations.
